(19) United States
(12) Patent Application Publication
(10) Pub. No.: US 2004/0003887 A1
(43) Pub. Date: Jan. 8, 2004

(54) Method and apparatus for manufacturing signs and banners

(76) Inventor: George Hunt, Bel Air, MD (US)

Correspondence Address: Robert E. Bushnell, Suite 300, 1522 K Street, N.W., Washington, DC, 20005, US

(21) Appl. No.: 10/189,383

(22) Filed: Jul. 8, 2002

(51) Int. Cl. B32B 31/00

(52) U.S. Cl. 156/252; 156/513

(57) ABSTRACT

The present invention relates to a method and apparatus for manufacturing signs or banners, by which at least one shape is removed from a first material, whereas the first material has a first characteristic, and then that first material is bonded to a second material, whereas the second material has a second characteristic different from the first characteristic. The bonding can be performed by contacting a rear surface of the first material to a front surface of the second material. Before the bonding is performed, an adhesive substance is applied to at least one selected from among the rear surface of the first material and the front surface of the second material. The first characteristic can be a first color and the second characteristic can be a second color different from the first color. The at least one shape that is removed from the first material can be a series of letters and numbers, for example, in order to form a sign depicting those letters and numbers. When the at least one shape is removed from the first material, the first material is perforated in a form of the at least one shape.

### BACKGROUND OF THE INVENTION

1. Technical Field

The present invention relates generally to the art of making signs, and more particularly to a method and apparatus utilizing a lamination process to manufacture signs and banners.

2. Related Art

Large signs and banners can be designed for a variety of different uses. A large flexible banner can be hung on the front of a house or towed by a small plane, and a large rigid sign can be positioned at a local gas station, for example.

I have found that a typical process used to make such large signs is time consuming because it requires that letters be cut out from a first material, arranged and spaced carefully, and then adhered to a background material. That labor intensive process requires a significant amount of time and skill partly because the letters must be manually arranged and carefully spaced apart from each other. If the spacing and arranging of the letters is performed hastily, it will be difficult to form a satisfactory sign. On the contrary, when the spacing and arranging of the individual letters is performed slowly and with exquisite care, the resulting sign is more likely to have a high quality appearance.

It would be desirable to be able to manufacture high quality signs in a less time consuming manner. Efforts have been made to improve methods of manufacturing signs or panels involving lamination.

Exemplars of recent efforts relating to signs or decorative panels include U.S. Pat. No. 3,440,746 for ASSEMBLY OF LETTERING AND THE LIKE issued to Richards on Apr. 29, 1969, U.S. Pat. No. 3,537,874 for PANEL WITH DECORATIVE SIMULATED INLAY AND PROCESS issued to Ramey on Nov. 3, 1970, U.S. Pat. No. 3,558,425 for LAMINATED TAPE FOR PRINTING WITH A PRESSURE TRANSMITTING TOP LAYER TO SEVER AN INTERMEDIATE BRITTLE LAYER issued to Massari on Jan. 26, 1971, U.S. Pat. No. 4,512,839 for MULTI-COLOR SIGN MAKING METHOD AND LAYUP issued to Gerber on Apr. 23, 1985, U.S. Pat. No. 4,909,884 for BANNER MANUFACTURING SYSTEM issued to Wormser on Mar. 20, 1990, and U.S. Pat. No. 5,073,424 for MULTI-COLORED ONE-STEP SIGN issued to Dressler on Dec. 17, 1991.

Richards '746 discloses a system for displaying characters for use in signs and displays. Ramey '874 discloses a panel with decorative simulated inlay and a process for forming the panel. Massari '425 discloses a laminated tape having an upper carrier layer embossed but uncut, an intermediate stencil layer cut during embossing, and a lower support layer. Gerber '839 discloses a multi-color sign making method. Wormser '884 discloses a banner manufacturing system used to form a banner having a flexible strip supporting indicia thereon. Dressler '424 discloses a multi-colored sign having at least two colors in addition to the background color.

While these recent efforts provide advantages, I note that they fail to adequately provide a new and improved method and apparatus for efficiently and conveniently utilizing a lamination process to manufacture signs and banners.

### SUMMARY OF THE INVENTION

Accordingly, the present invention has been made to solve the foregoing problems. It is an object of the present invention to solve the foregoing problems by providing a new and improved method utilizing lamination to efficiently and conveniently manufacture signs and banners.

It is another object of the present invention to solve the foregoing problems by providing a new and improved apparatus utilizing a lamination process to efficiently and conveniently manufacture signs and banners.

To achieve these and other objects in accordance with the principles of the present invention, as embodied and broadly described, the present invention provides a method of manufacturing a sign, comprising: removing at least one shape from a first material, the first material having a first characteristic; and bonding the first material to a second material, the second material having a second characteristic distinguishable from the first characteristic.

To achieve these and other objects in accordance with the principles of the present invention, as embodied and broadly described, the present invention provides an apparatus for manufacturing a sign, comprising: a laminating unit bonding a first material to a second material, the first material having a first characteristic, the second material having a second characteristic, the first and second characteristics being distinguishable, the first material having at least one shape removed therefrom before said laminating unit performs said bonding.

To achieve these and other objects in accordance with the principles of the present invention, as embodied and broadly described, the present invention provides a computer-readable medium having a set of computer-executable instructions for performing a method, the set of instructions comprising one or more instructions for: removing at least one shape from a first material, the first material having a first characteristic; and bonding the first material to a second material, the second material having a second characteristic distinguishable from the first characteristic.

The present invention is more specifically described in the following paragraphs by reference to the drawings attached only by way of example. Other advantages and features will become apparent from the following description and from the claims.

### BRIEF DESCRIPTION OF THE DRAWINGS

In the accompanying drawings, which are incorporated in and constitute a part of this specification, embodiments of the invention are illustrated, which, together with a general description of the invention given above, and the detailed description given below, serve to exemplify the principles of this invention.

FIG. 1 is a side view of a first embodiment of an apparatus used to manufacture signs and banners, in accordance with the principles of the present invention;

FIG. 2 is a top view of the apparatus shown in FIG. 1, in accordance with the principles of the present invention;

FIG. 3 is a top view of a second embodiment of an apparatus used to manufacture signs and banners, in accordance with the principles of the present invention;

FIG. 4 is a side view of a third embodiment of an apparatus used to manufacture signs and banners, in accordance with the principles of the present invention; and

FIG. 5 is a flowchart showing a process used to manufacture signs and banners, in accordance with the principles of the present invention.

### DETAILED DESCRIPTION OF THE PREFERRED EMBODIMENT

While the present invention will be described more fully hereinafter with reference to the accompanying drawings, in which preferred embodiments of the present invention are shown, it is to be understood at the outset of the description which follows that persons of skill in the appropriate arts may modify the invention here described while still achieving the favorable results of this invention. Accordingly, the description which follows is to be understood as being a broad, teaching disclosure directed to persons of skill in the appropriate arts, and not as limiting upon the present invention.

Illustrative embodiments of the invention are described below. In the interest of clarity, not all features of an actual implementation are described. In the following description, well-known functions or constructions are not described in detail since they could obscure the invention with unnecessary detail. It will be appreciated that in the development of any actual embodiment numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill having the benefit of this disclosure.

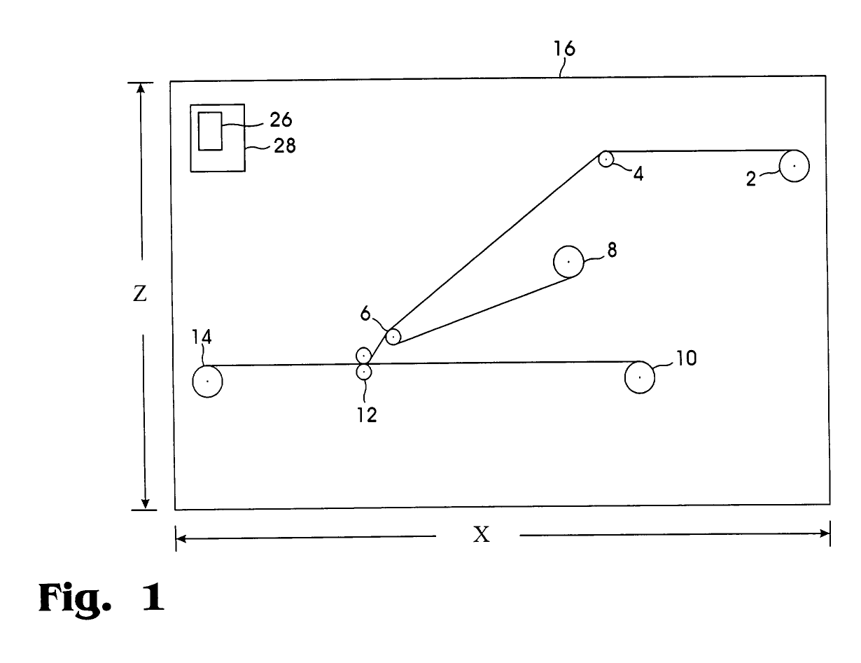

Please refer now to FIG. 1. The FIG. 1 is a side view of a first embodiment of an apparatus used to manufacture signs and banners, in accordance with the principles of the present invention. FIG. 1 shows a sign-making apparatus 16, which includes a sign roller 2, a background roller 10, a final roller 14, and a laminating section 12. The apparatus 16 also includes a separating roller 6, a guide roller 4, and a paper roller 8. A preferred embodiment of the inventive method and apparatus will be described in conjunction with the features of the apparatus 16 shown in FIG. 1.

The features of the inventive method and apparatus shall be discussed with reference to the manufacture of a sample sign. Let us suppose that a person wants to make a white sign with bright red letters that state “Happy Birthday.” In this example, most of the sign will be white, and the letters will stand out clearly because they are a bright red color.

In the case of the Happy Birthday sign, a flexible sheet of white adhesive material and a flexible sheet of red background material will be needed. Different materials can be selected for use with the inventive method and apparatus, in order to arrive at the desired colors, patterns, or textures. For the Happy Birthday sign, we shall be using a white adhesive material and a red background material. The letters in the words “Happy Birthday” are cut out from the white adhesive material. Perforations are made in the white adhesive material in the shapes of the letters to cut out the letters. The white letters are then discarded.

The sheet of white adhesive material is wound onto a first cylindrical tube. The first cylindrical tube is mounted onto sign roller 2. The roller 2 is referred to as sign roller 2 because the adhesive material will end up being the front surface of the sign. The sheet of red background material is wound onto a second cylindrical tube. The second cylindrical tube is mounted onto roller 10, which is referred to as background roller 10.

As shown in FIG. 1, the adhesive material is conveyed from the sign roller 2 to the guide roller 4, then to the laminating section 12, and lastly over to the final roller 14. Thus, the laminating section 12 is downstream from the sign roller 2, and the laminating section 12 is upstream from the final roller 14. The background material is conveyed from background roller 10 to the laminating section 12, and then over to the final roller 14.

While the adhesive material is being conveyed from sign roller 2 to the laminating section 12, the background material is simultaneously conveyed from background roller 10 to the laminating section 12. The laminating section 12 laminates the adhesive material to the background material and bonds the adhesive material to the background material to form the Happy Birthday sign. The sign then is conveyed from the laminating section 12 to the final roller 14. If the adhesive material and background material are sufficiently flexible, then the sign is wound up onto the final roller 14. The bonding performed by the laminating section 12 forms a long-lasting bond or permanent bond. In the preferred embodiment, the adhesive material cannot be peeled off the background material after the bonding is performed, because the adhesive material is adhered securely to the background material.

The adhesive material on sign roller 2 is a sheet that has a non-adhesive front side, an adhesive rear side, and a disposable paper backing temporarily adhered to the rear side. The paper backing is needed at roller 2 in order to prevent the adhesive material from sticking to itself.

The background material is a sheet that has a front side and a rear side. In the preferred embodiment, neither side of the background material is adhesive. The front side of the background material preferably has an appearance that is different from the appearance of the non-adhesive front side of the adhesive material, so that the letters for the sign stand out from the material surrounding the letters. The desired difference in appearance between the front of the adhesive material and the front of the background material could be caused by any number of factors, such as different colors, patterns, or textures, for example. The adhesive material could depict horizontal lines while the background material depicts vertical lines, for example.

In the Happy Birthday example, the non-adhesive front side of the adhesive material is white and the front side of the background material is a bright red color. The colors of the other surfaces are not important. Thus, in the Happy Birthday example, the appearance of the adhesive rear side of the adhesive material does not matter, the appearance of the disposable paper backing does not matter, and the appearance of the rear side of the background material does not matter.

The guide roller 4 is a pivot point to help guide the adhesive material through the apparatus 16. The guide roller 4 is used in apparatus 16 as shown in FIG. 1 in order to help guide the adhesive material to the laminating section 12, because the sign roller 2 is spaced apart from the background roller 10.

The separating roller 6 separates the disposable paper backing from the adhesive material. The paper roller 8 receives the disposable paper backing from the separating roller 6. The paper backing that accumulates on the roller 8 can be discarded.

Thus, the process of making the sign is as follows. To create the sample Happy Birthday sign using the apparatus 16, the letters for the sign are cut out from a flexible sheet of adhesive material. The precision of the cutting operation is important. The letters are cut out in the exact order and location desired for the final product. The letters can be cut out manually, or a computer-controlled cutting machine can be used, or the letters can be removed by other methods.

The letters that were cut from the adhesive material are then discarded. The adhesive material will end up being the front surface of the sign. The openings in the adhesive material formed by the cutting will be utilized as a part of the sign because the adhesive material will form the front surface of the final product. That is, the newly-formed negative space of the adhesive material will be utilized and will be an integral part of the sign.

In a preferred embodiment of the present invention, the letters are cut out from the sheet of adhesive material before the first cylindrical tube is mounted onto sign roller 2. As an alternative, it would be possible to perform the cutting at a point between the sign roller 2 and the guide roller 4, so that the words Happy Birthday can be cut into the adhesive material after the adhesive material leaves the sign roller 2.

Using the inventive method and apparatus, a large quantity of different high quality signs can be efficiently and conveniently made when the apparatus 16 is powered on and operated. For example, the phrase “Happy Birthday” can be cut into the sheet of adhesive material in ten different locations in order to create ten different Happy Birthday signs at once. When the apparatus 16 is powered on and operated, the final roller 14 will end up having ten different Happy Birthday signs. After the adhesive material is bonded to the background material by the laminating section 12, a final cutting operation can separate the ten Happy Birthday signs from each other.

The method of conveying the materials in the inventive method and apparatus is not restricted to one method. The adhesive material can have its edges perforated with spaced-apart holes by a perforating machine, and wheels with pins can be located at the appropriate positions on guide roller 4. In this way the velocity of the adhesive material conveyed from the sign roller 2 can be controlled. Similarly, the background material can have its edges perforated, and wheels with pins can be mounted at appropriate positions in apparatus 16 in order to control the velocity of the background material conveyed from background roller 10.

Of course, other methods can be used to control the conveyance of the adhesive material and the background material, in lieu of the above-described use of perforations, wheels, and pins. For example, the guide roller 4 can have a rubber surface which will control the movement of the adhesive material by gripping the surface of the adhesive material and facilitating the movement of the adhesive material from the sign roller 2 to the laminating section 12, obviating the need for the perforations, wheels, and pins.

Another method of conveying the materials is as follows. The materials can be pulled through the apparatus 16 by the rotation of the final roller 14. To accomplish this, a leader portion of the adhesive material and a leader portion of the background material can be threaded through the apparatus 16, along their respective paths of conveyance, and then each can be secured onto the hub of the final roller 14. In this way, when the final roller 14 is rotated, the adhesive material and the background material are simultaneously pulled through the apparatus 16 to the final roller 14 in a controlled manner. Other methods of controlling the rotation of rollers and conveyance of sheet materials through the apparatus 16 are available, of course. When a number of rollers are powered by the apparatus to control the conveyance of the adhesive material and background material, disadvantageous stretching can be reduced.

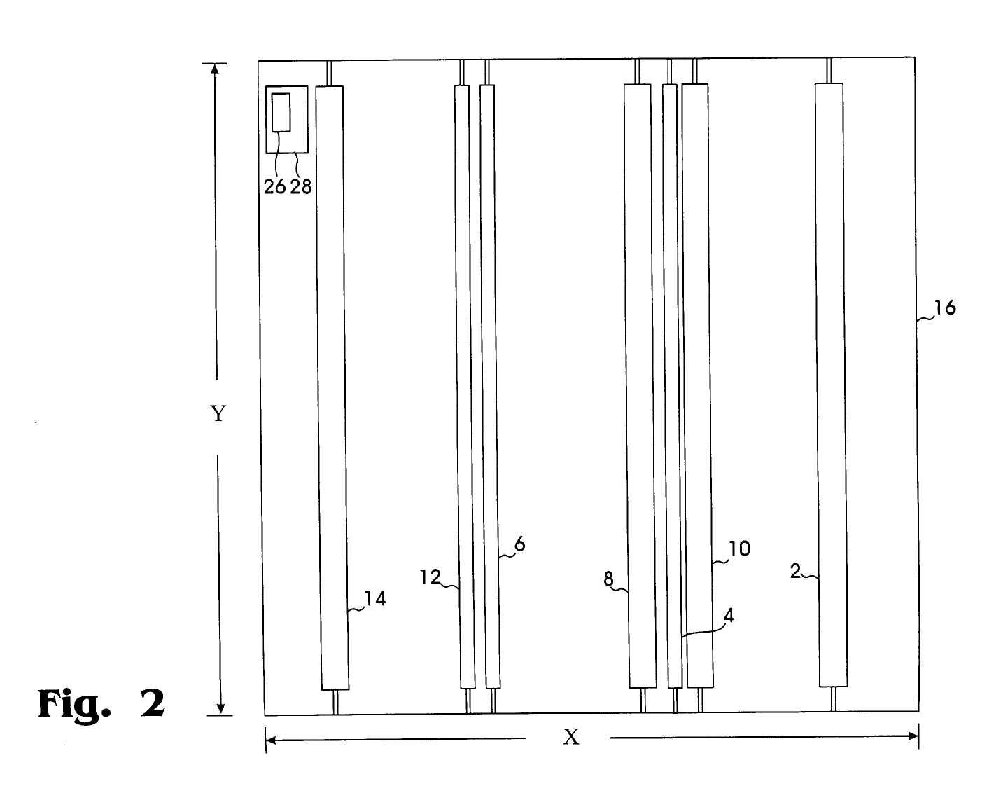

Please refer to FIG. 2. The FIG. 2 is a top view of the apparatus shown in FIG. 1, in accordance with the principles of the present invention. The arrangement of the rollers for the inventive method and apparatus is not limited to the arrangement shown in FIGS. 1 and 2. In an alternative embodiment, the guide roller 4 can be removed entirely. The positioning of the rollers can be modified as needed. For example, if a highly rigid adhesive material is selected in lieu of a highly flexible adhesive material, then the positions of the rollers 4, 6, and 8 can be moved down toward the background roller 10, in order to accommodate the rigidity of the adhesive material. Also note that the sign roller 2 would not be needed if a highly rigid adhesive material is selected because the rigid adhesive material would be fed into the apparatus 16 without the use of the sign roller 2.

As shown in FIG. 1, the apparatus 16 has an overall height Z and an overall width X. When the apparatus 16 is being constructed, the positioning of the rollers can be placed closer to one another in a manner which reduces the overall width X shown in FIGS. 1 and 2, if it is important to reduce the amount of space occupied by apparatus 16. Different rollers can be selected with different diameters. During construction of apparatus 16, the height Z and width X can be set to any preferred size, as long as there is enough room for the materials to be satisfactorily conveyed to and bonded at laminating section 12.

As shown in FIG. 2, the rollers have approximately the same length. The apparatus 16 has an overall length Y. When the apparatus 16 is being constructed, the length of the rollers and the overall length Y of the apparatus 16 shown in FIG. 2 can be engineered to be a preferred size. In the preferred embodiment shown in FIGS. 1 and 2, the length of the rollers is three feet, and the overall length Y of the apparatus 16 is slightly over three feet. The rollers could be replaced by shorter rollers shorter than three feet, or by longer rollers longer than three feet, as needed. The length of the rollers can be over six feet.

Because the background material is conveyed on a straight path in the preferred embodiment shown in FIG. 1, the background material can be a stiff material such as signboard, wood, cardboard, plastic, or other stiff material. If a stiff background material is used in lieu of a flexible background material, then the background roller 10 is not needed. The stiff background material can be simply fed into the apparatus 16. In that case, it would not be necessary to mount a roll of the background material onto the background roller 10. It will not be possible to wind a very stiff background material onto the background roller 10.

A variety of different materials can be utilized for adhesive materials and background materials. For example, the materials can be metal, nylon, vinyl, paper, signboard, plastic such as reflective plastic or other plastics, plastic board, wood, or many other materials.

The laminating section 12 can be adjusted to accommodate materials having different thicknesses. The adhesive material can have a thickness of 1/16 inch or ⅛ inch, for example. The background material can have a thickness of ¼ inch or ⅜ inch, for example.

When a thick background material is used, the lamination section 12 can be adjusted so that the background material can fit through section 12 and so that the background material will be properly bonded to the adhesive material. Also, when a thin background material is used, the lamination section 12 can be adjusted so that the background material will be properly bonded to the adhesive material.

In the preferred embodiment described above, letters are cut from an adhesive material, and the adhesive material is conveyed from roller 2 to the laminating section 12 where the adhesive material is bonded to the background material.

In the preferred embodiment, an effort is made to prevent dust and other unwanted particles from being in the region near separating roller 6 and laminating section 12. After the adhesive material passes separating roller 6 and before it reaches the laminating section 12, the rear side of the adhesive material is exposed. If dust or other unwanted particles adhere to the newly-exposed rear side of the adhesive material as that adhesive material passes from roller 6 to laminating section 12, the overall quality of the final product could be diminished.

The three rollers 2, 10, and 14 can be accessed by utilizing one or more openings or doors in the apparatus 16 near each of those rollers. Thus, a white roll of material can be removed from roller 2 and a blue roll of material can be placed on roller 2 by utilizing an opening or door favorably placed in a location near the roller 2. All components of apparatus 16 are accessible for maintenance or other purposes. In an alternative embodiment, one or more of the three rollers 2, 10, and 14 can be placed outside the box-like body of the apparatus 16, in order to enhance accessibility.

In the first embodiment shown in FIG. 1, a control unit 28 controls features of the apparatus 16. The control unit 28 can be a computer 28. The control unit 28 can control the cutting of the letters from the adhesive material. The control unit 28 can control the movement of the rollers. The control unit 28 can control the pressure applied by the laminating section 12. The control unit 28 can utilize a set of instructions stored on a storage medium 26, such as a hard disk drive 26, in order to control the features of the apparatus 16.

The storage medium 26 can include any computer-readable medium and any kind of computer memory such as floppy disks, conventional hard disks, removable hard disks, compact disc-read only memory discs (CD-ROMs), digital versatile disks (DVDs), flash read only memory (Flash ROM), nonvolatile read only memory (nonvolatile ROM), and random access memory (RAM).

Computers that have hard disk drives are well known and will not be described in detail here. The fact that computers can be used to control moving parts in machines is well known and the precise methods for performing those functions do not need to be described in detail here.

For example, the control unit can control the torque of the rollers. The rollers can be fitted with meshed gears in communication with the control unit. In the alternative, the rollers can be fitted with sprockets so that one or more chains mounted on the sprockets and coupled to the control unit enable the control unit to control the torque of the rollers. Or belts can be used in lieu of chains and sprockets.

In a less-expensive model of apparatus 16, a user is required to manually modify the location of the different rollers and the positioning of the laminating section 12 when adjustments are made to accommodate materials having different thicknesses. In a more-expensive model of apparatus 16, a user can merely press one or more buttons at the control unit to cause the control unit to modify the location of the different rollers and the positioning of the laminating section 12 as needed.

The materials are bonded together in the passageway in the middle of the rollers of the laminating section 12. The size of the passageway in the middle of the laminating section 12 can be enlarged or reduced in order to accommodate different thicknesses of materials. It can be advantageous to modify movement of the rollers and the size of the passageway in the middle of the laminating section 12 in accordance with the type of adhesive that is used. The size of the passageway can be modified to help prevent undesired air bubbles from being trapped between the adhesive material and the background material.

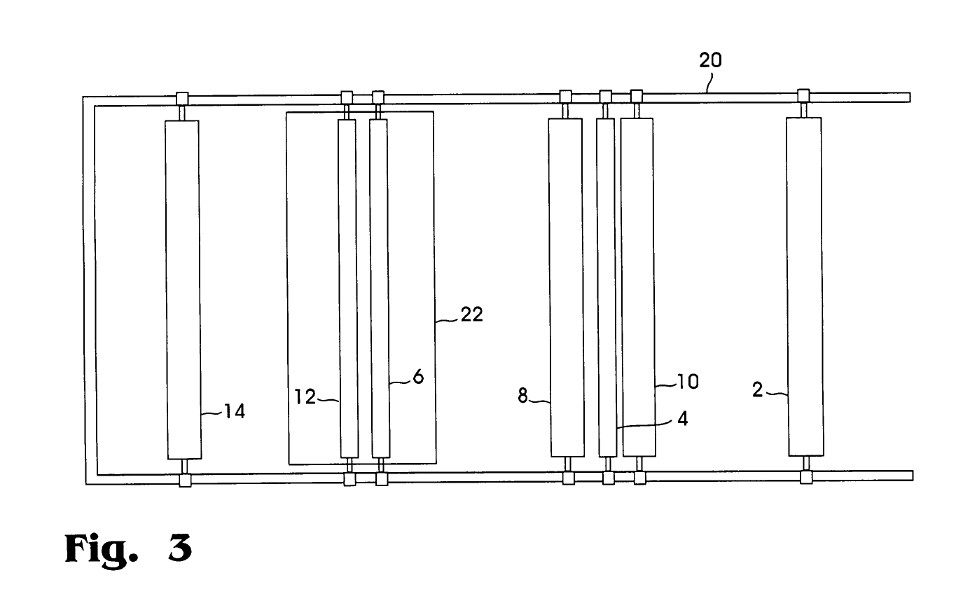

Please refer now to FIG. 3. The FIG. 3 is a top view of a second embodiment of an apparatus used to manufacture signs and banners, in accordance with the principles of the present invention. In the embodiment shown in FIG. 3, the apparatus 20 is different from the apparatus 16 for at least two reasons. First, the apparatus 20 does not have the exterior box-like body of the apparatus 16. Second, the apparatus 20 has the laminating section 12 and the separating roller 6 enclosed in a unit 22.

The exterior box-like body is not needed for apparatus 20, because a frame supports the rollers and laminating section. No exterior body is used. As shown in FIG. 3, the rollers and laminating section are highly accessible. As shown in FIG. 3, the rollers 2, 4, 6, 8, 10, and 14, and the laminating section 12 are set on a frame that does not have exterior walls, and thus the rollers are exposed to view.

As shown in FIG. 3, the unit 22 is used in order to prevent dust or other unwanted particles from sticking to the exposed rear side of the adhesive material after the disposable paper backing is removed from the adhesive material by separating roller 6.

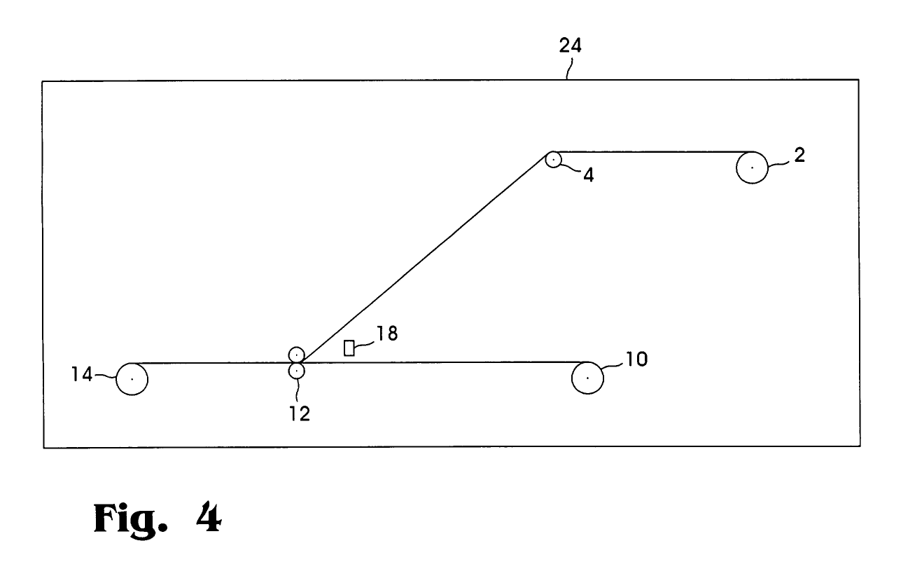

Please refer to FIG. 4. The FIG. 4 is a side view of a third embodiment of an apparatus used to manufacture signs and banners, in accordance with the principles of the present invention. In the apparatus 24 shown in FIG. 4, a first non-adhesive material is placed on roller 2, and a second non-adhesive material is placed on roller 10. The letters for the sign are cut out from the first non-adhesive material. In this embodiment, the roller 6 and the roller 8 are not needed, since there is no disposable paper backing. The unit 18 applies an adhesive substance to portions of the rear side of the first non-adhesive material at some point between roller 4 and the laminating section 12, or applies an adhesive substance to portions of the front side of the second non-adhesive material at some point between roller 10 and the laminating section 12.

As shown in FIG. 4, the unit 18 can be designed to utilize one or more adhesive substances and application techniques selected from a wide variety of different adhesive substances and techniques. For example, the adhesive substance can be a solid, liquid, or gas. If the adhesive substance is a liquid or gas, the unit 18 can spray it onto the first non-adhesive material or the second non-adhesive material, or both.

The unit 18 could be designed to brush a liquid adhesive onto one or both of the non-adhesive materials, for example. Or the unit 18 could be designed to place double-sided tape onto one or both of the non-adhesive materials. Or the unit 18 could be designed to heat a surface of one or both of the non-adhesive materials to cause the surface to become sticky or tacky. Or the unit 18 could be designed to apply a chemical that causes a chemical reaction with a surface of one or both of the non-adhesive materials in order to cause the surface to become sticky or tacky.

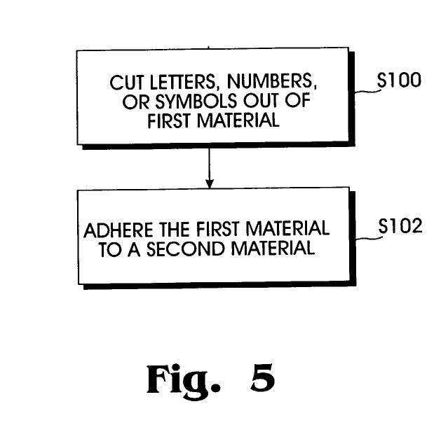

Please refer to FIG. 5. The FIG. 5 is a flowchart showing a process used to manufacture signs and banners, in accordance with the principles of the present invention. At step S100, shapes such as letters, numbers, or other symbols are cut out from a first material. At step S102, the first material is adhered or bonded to a second material. When the appearance of the first material is different from the appearance of the second material, a sign is formed as soon as the second step is performed.

In the Happy Birthday example, step S100 corresponds to cutting the letters of the two words “Happy Birthday” from the first material, that is, from the white adhesive material. The step S102 corresponds to the adhering or bonding of the white adhesive material to the second material, that is, to the bright red background material. As a result of steps S100 and S102, a white sign is formed that has “Happy Birthday” appearing in bright red.

In an alternative embodiment, a non-adhesive material can be used at sign roller 2 while an adhesive background material is used at background roller 10.

In another alternative embodiment, the adhesive material at sign roller 2 can have some backing other than the above-described disposable paper backing. Alternatively, an adhesive material at sign roller 2 could be used with no backing material whatsoever, if the non-adhesive front side of the adhesive material has a coating or composition such that the adhesive rear side of the adhesive material refuses to adhere to the front side of the adhesive material when at sign roller 2.

In another alternative embodiment of the applicant's invention, the sign roller 2 can be removed entirely, or merely moved out of the way. In this alternative embodiment, a sheet of adhesive material is fed into the apparatus 16. When the sign roller 2 is not used, the adhesive material can be selected from a range of more rigid materials. Thus, the adhesive material does not need to be able to be rolled up onto the sign roller 2. As an option, the final roller 14 can also be removed entirely or merely moved out of the way, so that the final product can be received from the apparatus 16 without needing to be rolled up onto the final roller 14. Thus, the final product can be a more rigid sign. Some materials are so rigid that any attempt to roll them onto a roller would cause permanent and irreversible damage.

As another option, the background roller 10 can be removed entirely or merely moved out of the way, so that the background material can be a more rigid material. Thus, the materials used to make the sign can be thicker or more rigid, since they do not need to be wound around any roller. In this manner, a stiff signboard material or other type of more rigid material can be used in the apparatus 16. The position of the guide roller 4 and settings for the laminating section 12 can be modified to accommodate adhesive materials and non-adhesive materials having different thicknesses and different rigidity levels.

In another alternative embodiment, the separating roller 6 shown in FIG. 1 can be moved much closer to the laminating section 12 shown in FIG. 1 to actually become a part of the laminating section 12. This can reduce the chance that dust or other unwanted particles will adhere to the newly-exposed adhesive rear side of the adhesive material.

As described above with reference to FIG. 1, the laminating section 12 comprises two rollers that rotate in opposite directions while the adhesive material and background material are conveyed through the laminating section 12. In this manner, the laminating section 12 presses the adhesive material to the background material and bonds those two materials together. The laminating section 12 is stationary during the bonding. That is, the laminating section 12 does not move toward the final roller 14 or toward the background roller 10 during the bonding. The distance between the rollers of the laminating section 12 can be modified to accommodate a thicker or thinner material.

In an alternative embodiment, the laminating section 12 itself is moved across the surface of a non-moving adhesive material and across the surface of a non-moving background material to bond the materials together.

In another alternative embodiment, the laminating section 12 is moved across the surface of a moving adhesive material and a moving background material to bond the materials together. In other words, the laminating section 12 moves to the right while the adhesive material is moved to the left. In this alternative embodiment, let us suppose that ten Happy Birthday signs are already cut from the adhesive material at sign roller 2, with reference to FIG. 1. The adhesive material and the background material are being conveyed from the right side of the apparatus 16 (as shown in FIG. 1) to the left side of the apparatus 16. At the beginning of the process, the laminating section 12 is stationary and is located at a position close to the final roller 14 and far from the separating roller 6 (this position of laminating section 12 is not shown in the drawings, but FIG. 1 can be referenced). When the first “Happy Birthday” approaches the laminating section 12, the laminating section 12 rapidly moves to the right from the “H” to the “y” of the first Happy Birthday sign, toward the separating roller 6, to cause a high quality bond with no air bubbles between the adhesive material and the background material for the first Happy Birthday sign. Then the laminating section 12 resets and returns to the leftmost position near the final roller 14 and waits for the second Happy Birthday sign to be advanced through apparatus 16 to the laminating section 12. When the second “H” arrives, the laminating section 12 again rapidly moves to the right from the “H” to the “y” of the second Happy Birthday sign, to cause a high quality bond with no air bubbles between the adhesive material and the background material for the second Happy Birthday sign. Then the laminating section 12 resets and returns to the position near the final roller 14 and waits for the third Happy Birthday sign.

The inventive method and apparatus can be used for manufacturing large signs and banners and also small signs and banners.

Although the preferred embodiments of the present invention have been disclosed for illustrative purposes, those skilled in the art will appreciate that various modifications, additions and substitutions can be made without departing from the scope and spirit of the invention. The scope of the invention shall not be defined by the above disclosed embodiments, but by the embodiments disclosed in the accompanying claims and the equivalents thereof

While the present invention has been illustrated by the description of embodiments thereof, and while the embodiments have been described in considerable detail, it is not the intention of the applicant to restrict or in any way limit the scope of the appended claims to such detail. Additional advantages and modifications will readily appear to those skilled in the art. The invention in its broader aspects is not limited to the specific details, representative apparatus and method, and illustrative examples shown and described. Departures may be made from such details without departing from the spirit or scope of the applicant's general inventive concept.

What is claimed is:

1. A method of manufacturing a sign, comprising:
removing at least one shape from a first material, the first material having a first characteristic; and
after said removing is performed, bonding the first material to a second material, the second material having a second characteristic distinguishable from the first characteristic.

2. The method of claim 1, said bonding being performed by contacting a rear surface of the first material to a front surface of the second material.

3. The method of claim 2, further comprising:
before said bonding is performed, applying an adhesive substance to at least one selected from among the rear surface of the first material and the front surface of the second material.

4. The method of claim 1, the first characteristic being a first color selected from a plurality of colors, the second characteristic being a second color selected from the plurality of colors, the first and second colors being distinguishable.

5. The method of claim 1, said at least one shape corresponding to at least one shape selected from among a plurality of letters, numbers, and symbols.

6. The method of claim 1, said removing of said at least one shape from the first material corresponding to perforating a portion of the first material in a form of said at least one shape.

7. An apparatus for manufacturing a sign, comprising:
a laminating unit bonding a first material to a second material, the first material having a first characteristic, the second material having a second characteristic, the first and second characteristics being distinguishable, the first material having at least one shape removed therefrom before said laminating unit performs said bonding.

8. The apparatus of claim 7, said laminating unit performing said bonding by contacting a rear surface of the first material to a front surface of the second material.

9. The apparatus of claim 8, further comprising:
an adhesive substance being applied to at least one selected from among the rear surface of the first material and the front surface of the second material.

10. The apparatus of claim 7, the first characteristic being a first color selected from a plurality of colors, the second characteristic being a second color selected from the plurality of colors, the first and second colors being distinguishable.

11. The apparatus of claim 7, said at least one shape corresponding to at least one shape selected from among a plurality of letters, numbers, and symbols.

12. The apparatus of claim 7, said at least one shape removed from the first material being removed by perforating a portion of the first material in a form of said at least one shape.

13. A computer-readable medium having a set of computer-executable instructions for performing a method, the set of instructions comprising one or more instructions for:
removing at least one shape from a first material, the first material having a first characteristic; and
after said removing, bonding the first material to a second material, the second material having a second characteristic distinguishable from the first characteristic.

14. The computer-readable medium of claim 13, said bonding being performed by contacting a rear surface of the first material to a front surface of the second material.

15. The computer-readable medium of claim 14, having a further set of instructions comprising one or more instructions for:
before said bonding is performed, applying an adhesive substance to at least one selected from among the rear surface of the first material and the front surface of the second material.

16. The computer-readable medium of claim 15, the first characteristic being a first color selected from a plurality of colors, the second characteristic being a second color selected from the plurality of colors, the first and second colors being distinguishable.

17. The computer-readable medium of claim 16, said removing of said at least one shape from the first material corresponding to perforating a portion of the first material in a form of said at least one shape.

18. The computer-readable medium of claim 13, the first characteristic being a first color selected from a plurality of colors, the second characteristic being a second color selected from the plurality of colors, the first and second colors being distinguishable.

19. The computer-readable medium of claim 13, said at least one shape corresponding to at least one shape selected from among a plurality of letters, numbers, and symbols.

20. The computer-readable medium of claim 13, said removing of said at least one shape from the first material corresponding to perforating a portion of the first material in a form of said at least one shape.
